(19) United States
(12) Patent Application Publication
(10) Pub. No.: US 2011/0290789 A1
(43) Pub. Date: Dec. 1, 2011

(54) MICROWAVE HEATING APPARATUS

(76) Inventors: Mitsuhiro Matsuzawa, Kashiwa (JP); Shigenori Togashi, Abiko (JP)

(21) Appl. No.: 13/113,150

(22) Filed: May 23, 2011

(30) Foreign Application Priority Data
May 26, 2010 (JP) 2010-120364

(51) Int. Cl. H05B 6/70

(52) U.S. Cl. 219/696

(57) ABSTRACT

A microwave heating apparatus in which microwaves from a single microwave generator is branched to a plurality of reaction tubes, a heating target material is irradiated with the microwaves while being continuously supplied into respective reaction fields, the reaction fields is heated and controlled simultaneously, parallelly and independently while eliminating the influence of reflected waves generated in the other reaction fields, and a very high throughput is obtained. In the apparatus, branch waveguides for branching microwaves generated from a microwave generator into N branch waves, N being an natural number, are provided, isolators for absorbing reflected waves generated in the reaction fields are provided between the branch waveguides and applicators, power monitors for measuring magnitudes of incident and reflected waves are provided between the isolators and the applicators, and tuners for adjusting impedances in waveguides are provided between the power monitors and the applicators.

### BACKGROUND OF THE INVENTION

The present invention relates to a microwave heating apparatus which heats a chemical liquid with microwaves.

Heating with microwaves is widely employed currently for a home-use microwave oven, but the microwave heating is also used for industrial use. For example, the microwave heating is used for rubber cure or vulcanization, tea leave drying, food sterilization and so on. These years, the microwave heating starts being employed even for chemical synthesis process.

Microwave heating in the chemical synthesis process, when compared with a conventional heating method by an external heating source, has been reported not only to be more increased or improved in reaction rate and other operational factors, but also to be more valid in microwave chemical reaction (refer to a book published from CMC Press and entitled “Microwave-assisted Chemical Process Technology”, page 10 to page 20 and page 119 to page 129, compiled under the supervision of Yuji Wada (referred to hereinafter as Non-patent Document 1)).

More specifically, since the microwave heating does not heat a heating target based on heat transfer from an external heat source but directly acts on molecules of the material of the heating target; when compared to the conventional heating method, the microwave heating has advantages of a remarkably-large heating rate and a very high heating work efficiency.

However, it is already known in microwave chemical reaction apparatuses so far developed that, as a throughput increases, a reaction rate is decreased.

More specifically, with respect to a dielectric material, use of microwaves has a limit in penetration depth. For example, when a microwave has a frequency of 2.45 GHz as a general use frequency, the penetration depth is generally about several cm, though it varies with the dielectric properties of the material. Accordingly, when the throughput is intended to be increased by making a heating vessel large and increasing a microwave output, the material absorbs the microwaves only with its surface and the microwaves can be shallowly penetrated into the interior of the material.

In the case of JP-A-6-94889 (referred to as Patent Document 1, hereinafter), for example, in order to obtain massive processing or a very high throughput, it is necessary to continuously flow a chemical liquid, make a reaction vessel large, and also increase a microwave output. In this method, however, it is undesirably considered in some cases that the microwaves can be absorbed by only the surface of the heating target material but cannot penetrate into the interior of the material, thus resulting in uneven heating (,though it is acceptably considered in some cases that, when a target material is merely heated, even somewhat uneven heating can involve less problem).

However, uneveness in a microwave absorption distribution can cause generation of irregular products, thus undesirably leading to quality deterioration of the products.

JP-A-2006-516008 (referred to as Patent Document 2, hereinafter) discloses a method of executing dielectric heating by applying electromagnetic wave to a plurality of reactors.

In order to solve the aforementioned problem of microwave penetration depth, there is considered a heating method of employing a plurality of reaction vessels not so large in size, connecting the plurality of reaction vessels in parallel, installing a single microwave oscillator to each of the reaction vessels, and then irradiating microwaves thereto.

However, the heating method has a problem that it is difficult for a magnetron widely being used for microwave generation to stably operate in a low microwave output region of from several W to tens of W. To avoid this, the aforementioned heating method of installing a single microwave generator to each of reaction vessels and connecting the microwave generators in parallel has been proposed. In this heating method, however, it is difficult to obtain stable heating operation.

To avoid this, it is considered to generate a low output region for each reaction field by generating microwaves from a single microwave generator and dividing the generated microwaves into a plurality of microwaves, as in Patent Document 2.

However, the method disclosed in Patent Document 2 has a problem that, when reflected waves of the microwaves generated in one of branch waveguides are diffracted and moved into the other branch waveguides, this may undesirably produce a detrimental influence.

More in detail, when reflected waves generated in one reaction field are diffracted and moved into the other branched waveguides, an impedance in each applicator varies and a microwave absorption efficiency for a heating target material is remarkably reduced. Or it becomes undesirably difficult to obtain even heating for a plurality of branched heating fields and to obtain stable and even heating operation.

### SUMMARY OF THE INVENTION

An object of the present invention is to provide a microwave heating apparatus which can have a very high throughput by avoiding adverse influence of reflected waves generated in another one of reaction fields and independently heating and controlling the reaction fields.

In accordance with an aspect of the present invention, the above object is attained by providing a microwave heating apparatus which includes a microwave generator for generating microwaves, a plurality of reaction tubes provided to irradiate a heating target material being moved within the reaction tubes with microwaves, and a plurality of applicators provided to install the reaction tubes. In this case, the microwave heating apparatus further includes branch waveguides for branching the microwaves generated by the microwave generator into a plurality of locations, isolators each provided between the branch waveguides and the applicators to absorb reflected waves generated at each reaction field, power monitors provided between the isolators and the applicators to measure magnitudes of incident and reflected waves, and tuners provided between the power monitors and the applicators to adjust impedances within the waveguides.

In accordance with the aspect, the above object is attained by arranging the microwave heating apparatus in such a manner that each of the branch waveguides divides incident microwaves into two equal microwaves and the branch waveguides are connected to branch the microwaves generated by the microwave generator into 2ⁿ (2 to the n-th power) (n being an integer) microwaves.

In accordance with the aspect, the above object is attained by arranging the microwave heating apparatus in such a manner that the apparatus includes a first material supplying unit for supplying a first material liquid and a second material supplying unit for supplying a second material liquid. The first material distributing unit for distributing the first material liquid into a plurality of locations is connected to the first material distributor at its downstream side, the first material distributor has a plurality of first material discharging tubes for discharging the first material liquid, the second material distributor for branching the second material liquid into a plurality of liquids is connected to the second material distributor at its downstream side, the second material distributor has a plurality of second material discharging tubes for discharging the second material liquid, a plurality of mixers for mixing the two liquids are connected to the first material discharging tubes and also to the second material discharging tubes, and the plurality of reaction tubes are connected to the plurality of mixers at their downstream sides.

In the aspect of the invention, the above object is attained by arranging the microwave heating apparatus in such a manner that each of the mixers for mixing two material fluids is a microreactor which has a micropassage having a diameter not larger than 1 mm.

In the above aspect of the invention, the above object is attained by arranging the microwave heating apparatus in such a manner that the applicators are arranged radially from the microwave generator, each of the isolators for absorbing the reflected waves is provided between the applicators and the branch waveguides, each of the power monitors for measuring magnitudes of incident and reflected waves of the microwaves is provided between the isolators and the applicators, each of the tuners for adjusting impedances of the waveguides is provided between the power monitors and the applicators.

In the aspect of the invention, the object is attained by arranging the microwave heating apparatus in such a manner that a temperature sensor for measuring a temperature of a heating target material is provided to each of the reaction tubes at its downstream side as its output side, output temperatures of the reaction tubes are measured by the temperature sensors to find an average temperature, and a control unit for controlling an outputs of the microwave generators or the tuners is provided so that the average temperature approaches a set temperature. In the aspect of the invention, the above object is attained by arranging the microwave heating apparatus in such a manner that a plurality of reaction tubes are provided in each of the applicators.

In the aspect of the invention, the above object is attained by arranging the microwave heating apparatus in such a manner that each of the reaction tubes is installed so that a distance between the reaction tubes is λ/2×n±10 mm (λ being a wavelength in waveguide, n being an integer).

In accordance with the present invention, there can be provided a microwave heating apparatus which can have a very large throughput by independently heating and controlling reaction fields while avoiding the influence of reflected waves generated in the other reaction fields.

Other objects, features and advantages of the invention will become apparent from the following description of the embodiments of the invention taken in conjunction with the accompanying drawings.

### BRIEF DESCRIPTION OF THE DRAWINGS

FIG. 1 is a perspective view of a microwave heating section in an embodiment of the present invention;

FIG. 2 is a side view of the microwave heating section in the embodiment of the invention;

FIG. 3 is a perspective view of a microwave heating apparatus in accordance with a first embodiment of the present invention;

FIG. 4 shows a piping system of the microwave heating apparatus of the first embodiment of the invention;

FIG. 5 is a perspective view of a microwave heating apparatus in accordance with a second embodiment of the present invention;

FIG. 6 shows plan and top views of a conventional branch waveguide;

FIG. 7 shows plan and top views of a branch waveguide in the first and second embodiments of the present invention;

FIG. 8 is a perspective view of a microwave heating apparatus in accordance with a third embodiment of the present invention; and

FIG. 9 is a side view of a microwave heating apparatus in accordance with another embodiment.

### DESCRIPTION OF THE EMBODIMENTS

As has been mentioned earlier, there is recently a strong demand for a large quantity of chemical reaction processing of chemical liquid or the like based on microwave heating. For satisfying this demand, it is considered to perform heating operation with a reaction tube branched into a plurality of branches to irradiate a heat target material with microwaves, as in Patent Document 2. In this method, the quantity of processing of a chemical liquid or the like is increased by continuously passing the chemical liquid through the tube and irradiating the target material with microwaves from the outside of the tube.

Inventors of the present application have conducted tests of irradiating a chemical liquid with microwaves with use of a reaction tube having a plurality of divided branches as shown in Patent Document 2. As a result of the tests, it has been found that heating of the chemical liquid is made uneven and its chemical reaction also becomes inconsistent.

As a result of examining and studying the causes of the above phenomenon in various ways, it has been found that, heating with use of the reaction tube having a plurality of branches involves generation of reflected waves, the reflected waves cause uneven heating, thus resulting in inconsistent reaction.

When the inventors of the present application have examined and studied isolation of reflected waves in various manners. As a result, the inventors have found a new application of an isolator which has a function of isolating a circuit between input and output signals when viewed as a DC circuit and which is widely used for prevention of signal wraparound, device protection and so on.

As a result, the inventors of the present application have considered installation of this isolation between a branch waveguide and an applicator.

Explanation will be made in connection with an embodiment of the present invention by referring to the attached drawings.

### Embodiment 1

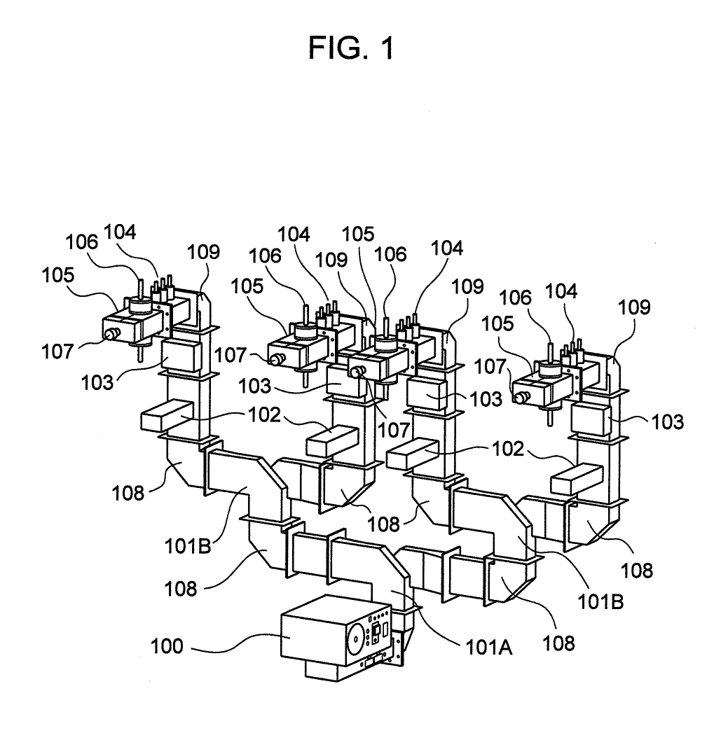

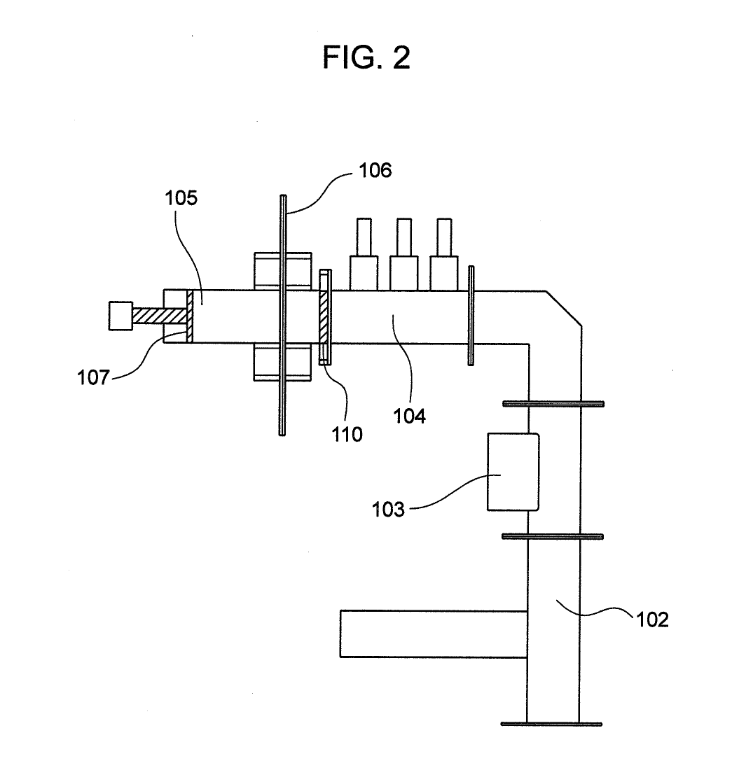

A first embodiment of the present invention will be explained in connection of a microwave heating apparatus shown in FIGS. 1 and 2.

FIG. 1 is a perspective view of a microwave heating section in the present embodiment.

FIG. 2 is a side view of the microwave heating section in the present embodiment.

In FIG. 1, the microwave heating section includes a microwave generator 100 for generating microwaves, and a branch waveguide 101A for branching the microwaves into two waves is connected to the microwave generator 100. A branch waveguide 101B is used to branch the branched microwaves further into two microwaves. An isolator 102 is provided to absorb reflected waves. A power monitor 103 is used to measure magnitudes of incident and reflected waves. A tuner 104 is provided to adjust an impedance in the apparatus.

A reaction tube 106, which functions to make a heating target material to flow into the interior thereof, is installed with an applicator 105. A H-plane waveguide 108 is provided to bend the microwaves by an angle of 90 degrees relative to a magnetic field plane and then to transmits it. The microwaves are bent by an E-plane waveguide 109 by an angle of 90 degrees to an electric field plane and then transmitted.

As the material of the reaction tube 106, glass, resin such as Teflon (registered trademark), polyethylene or polypropylene, or ceramic such as alumina, having small dielectric constants and capable of less absorbing microwaves, is suitable. It is desirable that the reaction tube have an inner diameter not larger than 5 cm. In the present embodiment, explanation will be made assuming that the microwave generator 100 generates microwaves of 2.45 GHz, and that the applicator 105, the tuner 104, the power monitor 103, the isolator 102 and so on satisfy WRJ-2 Standards (aperture of 109.2 mm×54.6 mm). Reference numeral 107 denotes a movable short-circuit plate.

In FIG. 2, a partition plate 110 is provided between the tuner 104 and the applicator 105. So long as the partition plate 110 is provided, even when the reaction tube is damaged, flowing out of the heating target material can be prevented, and the tuner 104, the power monitor 103, the isolator 102, the branch waveguides 101A, 101B, the microwave generator 100, etc can be avoided from being damaged.

The partition plate 110 is made of suitably resin such as Teflon, polyethylene or polypropylene, or of ceramic such as alumina, having small dielectric constants and capable of less absorbing microwaves.

With such an arrangement, the microwave generated by the microwave generator 100 is divided by the branch waveguide 101A into two equal waves, each of which is further divided by the branch waveguide 101B into two equal waves. That is, the generated microwaves are divided into a total of 4 equal waves. The 4 divided microwaves are transmitted up to the respective applicators 105 and absorbed by the heating target material flowing through the interior of the reaction tube 106. The heating target material flowing through the interior of the reaction tube 106 absorbs the microwaves to promote its reaction.

In the present embodiment, explanation has been made as to a 2-branch waveguide for branching the microwaves into two waves. The reason for use of the 2-branch waveguide is as follows.

That is, since the 2-branch waveguide can have exactly the same 2 branch waveguides, the branch waveguides can have equal energy loss, etc., and thus the microwaves can be distributed equally to the respective branch waveguides. Therefore, the microwaves can be easily branched into 2ⁿ (2 to the n-th power) microwaves (n being an integer) by coupling a plurality of such 2-branch waveguides each other.

Meanwhile, when variations in the energy loss between the branch waveguide presents no problem, the waveguide may be divided not into 2 branches but into more than 2 branches.

In the present embodiment, the microwaves transmitted up to the applicator 105 is reflected by the movable short-circuit plate 107, and interference takes place between incident and reflected waves, thus generating a standing wave. In other words, the microwaves within the applicator have a zone having a strong intensity of electric field and a zone having a strong intensity of magnetic field in a microwave transmission direction.

Generally speaking, heating of a dielectric material with use of microwaves is proportional to the square of electric field intensity. In order to make a heating efficiency large, it is desirable to install the reaction tube 106 at a location having a strong electric field intensity. Meanwhile, when a strong magnetic field effect is desirable, the reaction tube 106 may be installed at a location having a strong magnetic field.

To this end, in the present embodiment, the movable short-circuit plate 107 is provided to be movable in the microwave transmission direction so that the installation positions of the reaction tube 106 can be adjusted at a location having a strong intensity of electric field or a strong intensity of magnetic field. In other words, the reaction tube 106 can be adjusted in position relative to electric and magnetic 43 fields.

The tuner 104 is used to adjust an impedance in the microwave heating apparatus. By optimizing the tuner (impedance matching), the microwaves can be subjected to multiple reflection between the tuner 104 and the movable short-circuit plate 107, and the microwaves can efficiently absorbed into the heating target material flowing through the interior of the reaction tube 106. In this connection, the tuner 104 is suitably a 3-stub tuner, an EH tuner or the like.

With respect to the reflected waves generated between the isolator 102 and the movable short-circuit plate 107, the reflected waves reaching the isolator 102 are all absorbed by the isolator 102. In the case of no provision of the isolator 102, reflected waves generated in a reaction field may be undesirably diffracted to the other branched reaction fields, which may resulting undesirably in change an impedance in the apparatus.

For this reason, even after impedance matching is carried out, generation of an abnormality in a reaction field influences other reaction fields, the microwaves are not absorbed into the heating target material at all, thus completely disabling the heating operation.

However, in the present embodiment, the reflected waves generated in each reaction field is fully absorbed into the isolator 102 installed at each reaction field, so that heating operations at the respective reaction fields can be simultaneously and independently carried out, thus enabling a stable and very high throughput.

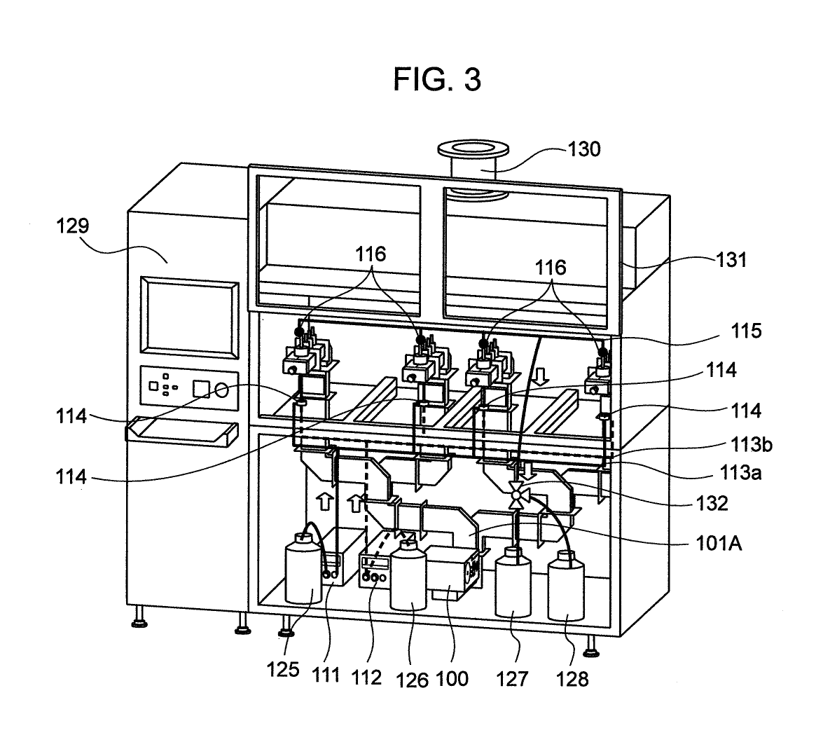

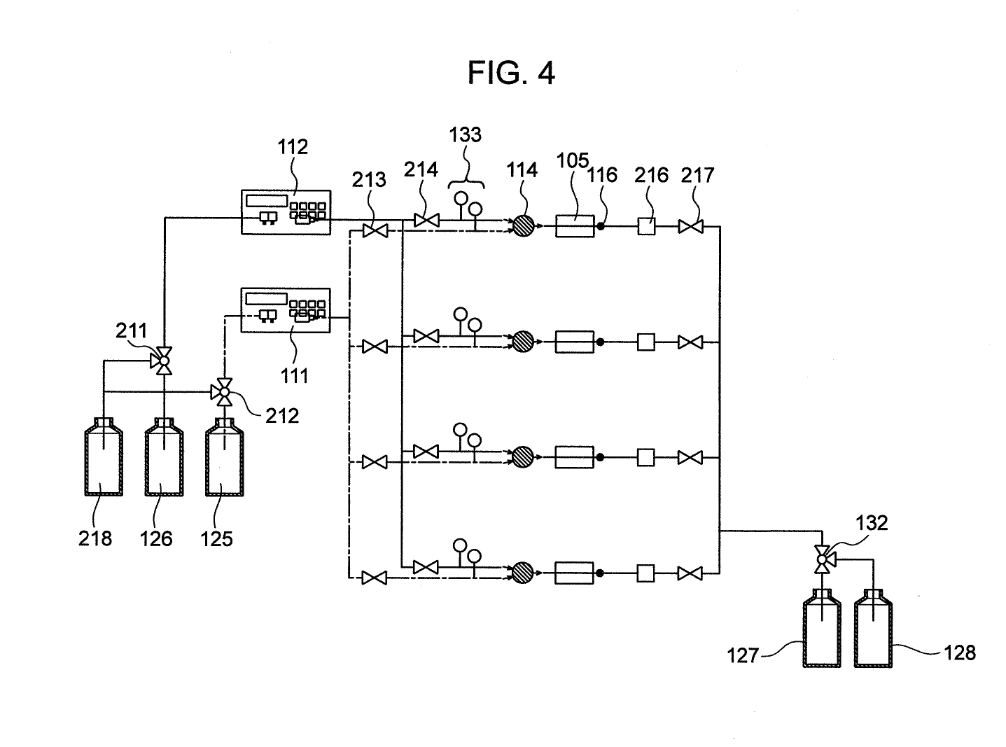

By referring to FIGS. 3 and 4, explanation will be made as to the detailed structure of the apparatus and its heating method.

FIG. 3 shows a perspective view of a microwave heating apparatus in accordance with a first embodiment of the present invention.

FIG. 4 shows a piping system of the microwave heating apparatus in accordance with the first embodiment of the present invention.

In FIGS. 3 and 4, the microwave heating apparatus having the microwave generator 100 includes a first material tank 125 containing a first material liquid, a second material tank 126 containing a second material liquid, a cleaning fluid tank 218 containing a cleaning fluid, a product tank 127 for collecting a product, and a waste fluid tank 128 containing a waste fluid as shown in FIG. 4.

A supply fluid pump 111 is used to supply a first material liquid, and a supply fluid pump 112 is to supply a second material liquid. A first material distributor 113a is provided to distribute the first material liquid to a plurality of locations, and a second material distributor 113b is to distribute the second material liquid to a plurality of locations.

A mixer 114 is used to mix the first and second materials. The microwave heating apparatus includes a control/monitoring system 129, an exhaust duct 130, a opening/closing door 131, pressure sensors 133 (shown in FIG. 4), flow sensors 216 (shown in FIG. 4), three-way valves 211, 212, 132, and two-way valves 213, 214, 217.

The first and second materials are supplied by the respective supply fluid pumps 111 and 112 to the first material distributors 113a and 113b, which in turn distribute the materials to a plurality of locations respectively. The distributed first and second materials are mixed at the associated mixer 114, the mixed fluid is sent to the associated reaction tube 106 and irradiated with microwaves to promote its reaction. Reference numeral 105 denotes an applicator.

Reaction fluids heated with microwaves in the associated reaction tubes 106 are combined at a junction 115, and the combined fluid is collected into the product tank 127 or into the waste fluid tank 128 under control of a valve 132. Reference numeral 101 A denotes a branch waveguide.

According to the present embodiment, the same heating operation can be carried out parallelly, simultaneously and consistently at a plurality of reaction fields. In order that the opening/closing door 131 completely prevents leakage of microwaves, it is preferable that the opening/closing door is provided with a punching metal.

As the mixer 114, in particular, a microreactor is used more effectively. The microreactor is a reactor which has a passage of a diameter of from about tens of gm to hundreds of gm. Mixing of materials depends eventually on molecule diffusion, and a time necessary for the mixing is proportional to the square of diffusion distance. For this reason, by remarkably reducing the diffusion distance with use of the micropassage of the microreactor, such high-speed and efficient mixing as not obtained in an ordinary mixer can be achieved.

Accordingly, when the microreactor is used as the mixer 114, the first and second materials can be efficiently mixed at a high speed within the microreactor, the mixed material is sent into the reaction tube 106, and then irradiated with microwaves. As a result, the effect of the high-speed mixing with use of the microreactor and the effect of heating with microwaves enable increase of a reaction efficiency and stable reaction, and further enables processing with a very high throughput with the reaction fields arranged in parallel. That is, the microwave heating apparatus can exhibit highly excellent effects.

The above explanation has been made as to the method of performing the heating process simultaneously in four reaction tubes with use of the four reaction fields. However, when very-high throughput processing is unnecessary due to study and examination of reaction conditions including microwave output and tuner adjustment, the heating process can be carried out with use of only one reaction field.

In other words, when the valves 213, 214, 217 are operated to cause the heating target material to flow into a single reaction field and to be irradiated with microwaves, heating process can be carried out with use of the single reaction field. In accordance with the present invention, since an isolator is not provided for each of the branched reaction fields, reflected waves generated in the reaction fields having the heating target material not flowing thereinto are all absorbed by the isolators provided for the respective reaction fields. Thus the apparatus can avoid such an adverse wraparound influence as reflected waves generated in other reaction fields not used are diffracted to and moved into the reaction field being used.

Thus, in accordance with the present invention, even when only one reaction field is used, a stable heating process can be attained. It is as a matter of course that the heating process can be executed with use of not one reaction field but two or three reaction fields.

Since the reaction fields can be independently heated and controlled in the present invention, different heating processes can be carried out simultaneously for four used different reaction fields. When impedance matching is made in such a manner that a plurality of different reaction fields have different heating temperatures, processes, for example, with different heating temperatures or different sorts of heating target materials can also be carried out simultaneously parallelly with use of the plurality of reaction fields.

Explanation will next be made as to such temperature control method that the exit temperature of a heating target material becomes constant.

As shown in FIGS. 3 and 4, a thermocouple or a fiber optic probe is provided at an exit 116 of each reaction tube. In the present invention, a heating target material is continuously made to flow into the reaction tubes and irradiated with microwaves, thus heating the heating target material. The thermocouple or the fiber optic probe measures the exit temperature of the heated target material.

When four reaction fields are parallelly heated as in the present embodiment, the exit temperatures of the heated material at the four reaction fields are measured and the measured values are fed back to control the output of the microwaves, whereby control can be made in such a manner that an average value of the exit temperatures becomes a target temperature. When the tuners 104 are adjusted according to the exit temperatures of the heated material at the four reaction fields, the target temperature can be finely adjusted on the basis of the exit temperatures of the heated material at the respective reaction fields. The adjustment of the tuners 104 may be made manually or automatically.

### Embodiment 2

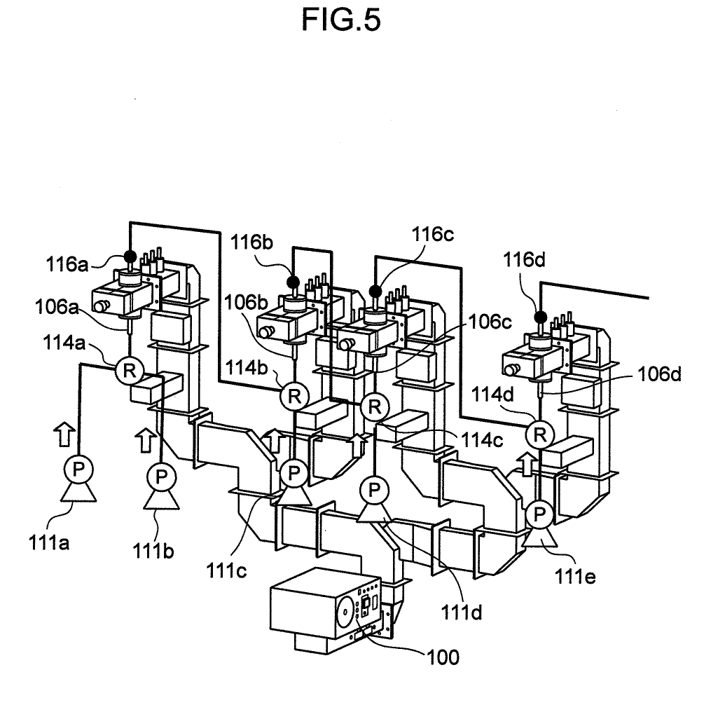

Explanation will then be made as to a second embodiment with reference to FIGS. 1 and 5.

FIG. 5 is a perspective view of a microwave heating apparatus in accordance with a second embodiment of the present invention.

In FIG. 5, the present embodiment includes, in addition to the microwave heating section of FIG. 1, supply fluid pumps 111a to 111e for supplying a plurality of materials and mixers 114a to 114d for mixing two fluids.

The microwave heating apparatus in accordance with the present embodiment can execute a plurality of heating processes in a time series manner. For example, first and second materials are supplied by the supply fluid pumps 111a and 111b to the mixer 114a for mixture. The mixed fluid is caused to flow into a reaction tube 106a, and is irradiated with microwaves, thus carrying out a heating process. The heated reaction fluid is caused to flow further into another mixer 114b and mixed therein with a third material supplied by the supply fluid pump 111c. The mixed fluid is caused to flow into a reaction tube 106b, and is irradiated with microwaves, thus carrying out a heating process similarly to the above case. The reaction fluid subjected to the heating process herein is caused to flow into another mixer 114c and mixed therein with another material.

In the present embodiment, in this manner, heating processes with different heating temperatures or different processing materials can be carried out in a time series manner. Exit temperatures of the reaction tubes are measured by temperature sensors provided at exit measurement points 116a to 116d. Tuners provided at the respective reaction fields and an output of the microwave generator can be adjusted on the basis of the measured temperatures, and temperatures of the reaction fluids heated at the respective reaction tubes 106a to 106d can be independently adjusted.

In the present embodiment, when microreactors are used as the mixers 114a to 114d as mentioned in Embodiment 1, the effect of high-speed mixing caused by the microreactors and the effect of heating with microwaves enable increase of a reaction efficiency and stable reaction.

Next, explanation will be made as to the structure of a branch waveguide in the first and second embodiments by referring to FIGS. 1, 6 and 7.

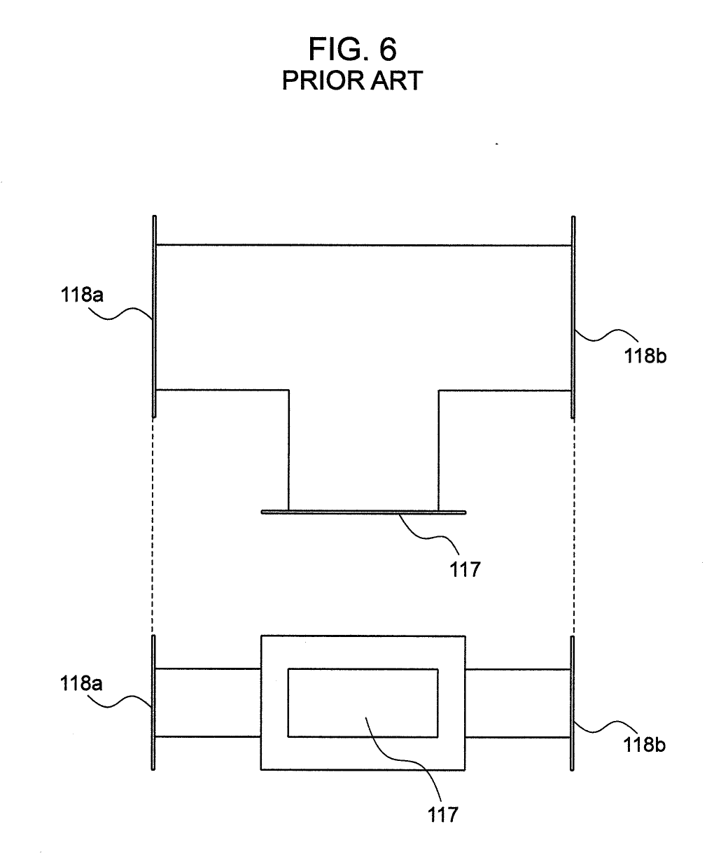

FIG. 6 shows plan and top views of a conventional branch waveguide.

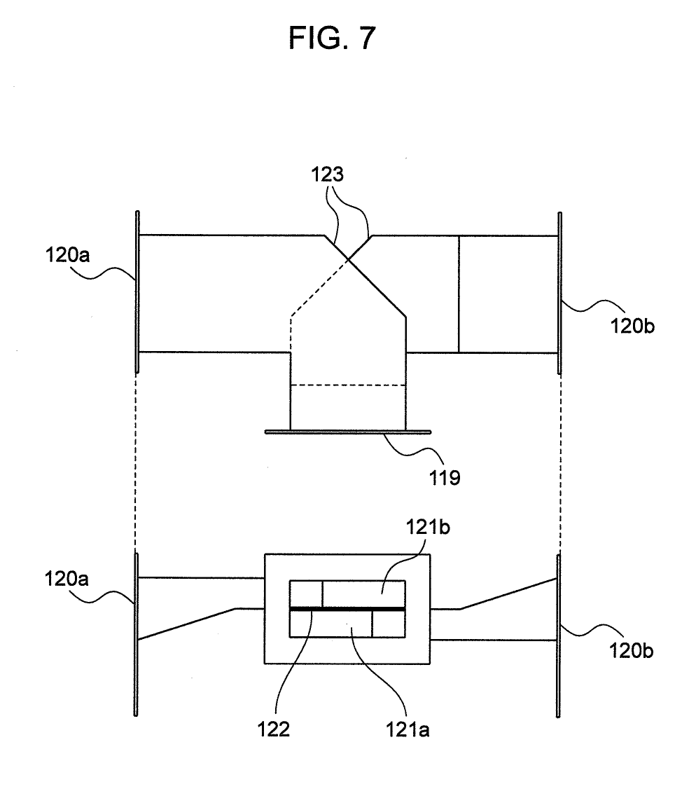

FIG. 7 shows plan and top views of a branch waveguide in the first and second embodiment of the present invention.

In the present invention, microwaves generated by a microwave generator 100 is branched by a branch waveguide 101 into two waves. When the branch waveguide has such a structure having branches simply directed in right and left directions by an angle of 90 degrees as shown in FIG. 6, the microwaves cannot be transmitted efficiently. In this case, for example, according to calculation based on electromagnetic wave simulation, incident microwaves from an entrance 117 can reach exits 118a, 118b of the branch waveguide by small quantities, that is, only about 30% of the incident microwaves can be transmitted to the exits 118a, 118b of the branch waveguide.

In the structure of the branch waveguide in the embodiment shown in FIG. 7, on the other hand, incident microwaves from the entrance 119 of the branch waveguide is branched by a partition plate 122 into waves 121a and 121b with an identical surface area in a shorter-side direction of plane of a rectangular cross section of the waveguide. The partition plate 122 is provided with tapers 123 of 45 degrees downstream thereof, so that the two equally divided microwaves are transmitted to exits 120a, 120b of the branch waveguide. In this case, calculation of electromagnetic wave simulation results in that about 99% of the incident microwaves from the entrance 119 are transmitted to the exits 120a, 120b of the branch waveguide. In other words, the branch waveguide in the present embodiment can efficiently branch the microwaves into two waves and then transmitted.

### Embodiment 3

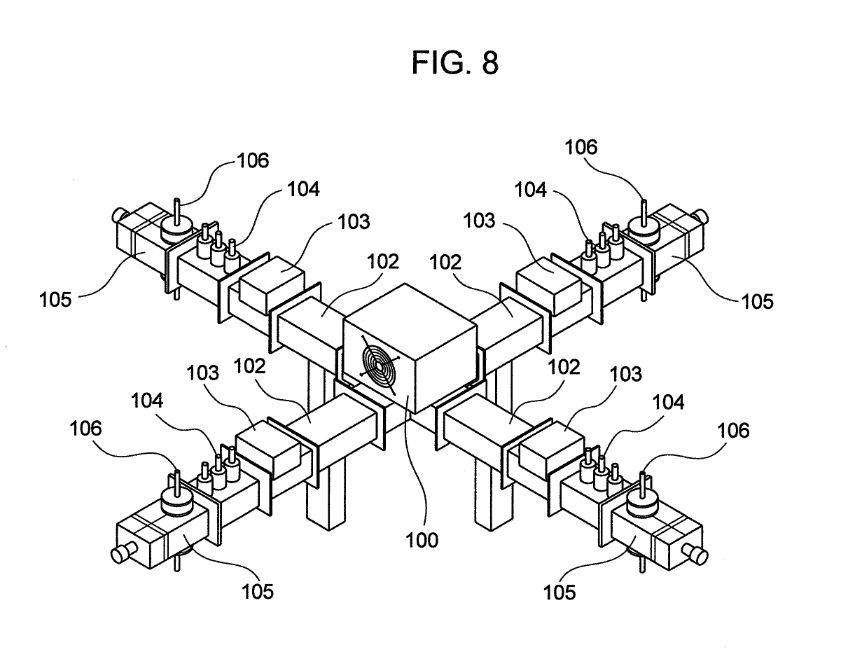

A third embodiment of the present invention will then be explained with reference to FIG. 8.

FIG. 8 is a perspective view of a microwave heating apparatus in accordance with a third embodiment of the present invention.

In FIG. 8, the microwave heating apparatus of the present embodiment includes a microwave generator 100 for generating microwaves, isolators 102 for absorbing reflected waves, power monitors 103 for measuring magnitudes of incident and reflected waves, tuners 104 for adjusting an impedance in the apparatus, reaction tubes 106 through which heating target materials flow, and applicators 105 provided to install the reaction tubes 106. In the present embodiment, when the reaction fields are arranged radially from the microwave generator 100 as its center, the reaction fields can be heated simultaneously, parallelly and independently.

Although the present embodiment has been explained in connection with the example where the four reaction fields are radially arranged, any number of reaction fields other than four may be similarly radially arranged as a matter of course.

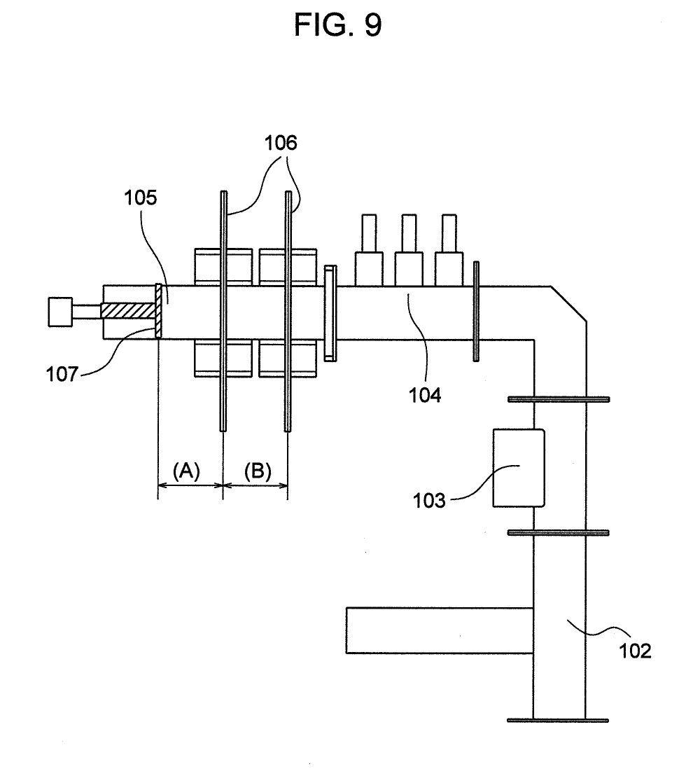

Another embodiment will be explained by referring also to FIG. 9.

FIG. 9 shows a side view of microwave heating apparatus in accordance with another embodiment.

In FIG. 9, explanation has been made in connection with the example where the single reaction tube is provided to the single application in the first, second and third embodiments. However, two or more reaction tubes may be provided to the single applicator as shown in this drawing.

As mentioned above, a standing wave is present within the application. When X denotes a wavelength in waveguide, an electric field has a maximum intensity at a location where a distance from a movable short-circuit plate is about λ/4±n×λ/2 (n=1, 2, 3, . . . ) . . . (1).

With respect to magnetic field, on the other hand, a magnetic field has a maximum intensity at a location where a distance from the movable short-circuit plate is about n×λ/2 (n=1, 2, 3, . . . ) . . . (2). Accordingly, when a distance (A) from movable short-circuit plate between one of the reaction tubes closest to the movable short-circuit plate and the movable short-circuit plate is such a value as shown by the above Equation (1) or (2) and a distance (B) between the reaction tubes is such a value as shown by n×λ/2 (n=1, 2, 3, . . . ), all the reaction tubes can be located at strong electric or magnetic field intensities and the heating target material can be efficiently irradiated with microwaves. Preferably, since an internal electromagnetic field distribution somewhat varies with the dielectric properties of the reaction tubes and the heating target material, it is desirable to set the distance (B) between the reaction tubes at n×λ/2±10 mm (n=1,2,3, . . . ).

In accordance with the present invention, in this manner, there can be provided a microwave heating apparatus in which microwaves from a single microwave generator can be branched into a plurality of reaction fields, a heating target material can be irradiated with the microwaves while being continuously supplied into the respective reaction fields, the reaction fields can be heated and controlled simultaneously, parallelly and independently while eliminating the influence of reflected waves generated in the other reaction fields, and a very high throughput can be obtained.

As has been explained above, in accordance with the present invention, since the problem with the penetration depth of the microwave, the heating target material can be evenly heated with a very high throughput, while preventing the microwave absorption distribution from becoming uneven. Even when microwave irradiation of low output is required for the respective reaction field, branching of the microwaves into a plurality of reaction fields enables the low-output microwaves to be supplied to the respective reaction fields, whereby a stable heating process can be achieved even for a low output region.

Further, the adverse influence of the reflected waves generated in one reaction field and diffracted to and moved into the other reaction fields on the other reaction fields can be prevented, and thus the reaction fields can be heated and controlled simultaneously and independently.

That is, the present invention can exhibit a highly excellent effect that consistent and stable processing can be achieved. In accordance with the present invention, since a plurality of reaction fields can be heated and controlled independently as mentioned above, heating processes based on different heating conditions at different reaction fields can be carried out simultaneously and parallelly.

It should be further understood by those skilled in the art that although the foregoing description has been made on embodiments of the invention, the invention is not limited thereto and various changes and modification may be made without departing from the spirit of the invention and the scope of the appended claims.

1. A microwave heating apparatus comprising:
a microwave generator for generating microwaves;
a plurality of reaction tubes provided to irradiate a heating target material being moved within the reaction tubes with microwaves,
a plurality of applicators provided to install the reaction tubes;
branch waveguides for branching the microwaves generated by the microwave generator into a plurality of locations;
isolators each provided between the branch waveguides and the applicators to absorb reflected waves generated at each reaction field;
power monitors provided between the isolators and the applicators to measure magnitudes of incident and reflected waves; and
tuners provided between the power monitors and the applicators to adjust impedances within the waveguides.

2. The microwave heating apparatus according to claim 1, wherein each of the branch waveguides divides incident microwaves into two equal microwaves, and the branch waveguides are connected to branch the microwaves generated by the microwave generator into 2 to the n-th power of microwaves, n being an integer.

3. The microwave heating apparatus according to claim 1, comprising:
a first material supplying unit for supplying a first material liquid; and
a second material supplying unit for supplying a second material liquid,
wherein the first material distributing unit for distributing the first material liquid into a plurality of locations is connected to the first material distributor at its downstream side, the first material distributor has a plurality of first material discharging tubes for discharging the first material liquid, the second material distributing unit for branching the second material liquid into a plurality of liquids is connected to a second material distributor at its downstream side, the second material distributor has a plurality of second material discharging tubes for discharging the second material liquid, a plurality of mixers for mixing the two liquids are connected to the first material discharging tubes and also o the second material discharging tubes, the plurality of reaction tubes are connected to the plurality of mixers at their downstream sides.

4. The microwave heating apparatus according to claim 1, wherein each of the mixers for mixing two material fluids is a microreactor which has a micropassage having a diameter not larger than 1 mm.

5. The microwave heating apparatus according to claim 1, wherein the applicators are arranged radially from the microwave generator, each of the isolators for absorbing the reflected waves is provided between the applicators and the branch waveguides, each of the power monitors for measuring magnitudes of incident and reflected waves of the microwaves is provided between the isolators and the applicators, and each of the tuners for adjusting impedances of the waveguides is provided between the power monitors and the applicators.

6. The microwave heating apparatus according to claim 1, wherein a temperature sensor for measuring a temperature of a heating target material is provided to each of the reaction tubes at its downstream side as its output side, output temperatures of the reaction tubes are measured by the temperature sensors to find an average temperature, and a control unit for controlling an outputs of the microwave generators or the tuners is provided so that the average temperature approaches a set temperature.

7. The microwave heating apparatus according to claim 1, wherein a plurality of reaction tubes are provided in each of the applicators.

8. The microwave heating apparatus according to claim 7, wherein each of the reaction tubes is installed so that a distance between the reaction tubes is λ/2×n±10 mm, X being a wavelength in waveguide, and n being an integer.
